(19) United States
(12) Patent Application Publication
(10) Pub. No.: US 2025/0209781 A1
(43) Pub. Date: Jun. 26, 2025

(54) DISENTANGLED RECURRENT REPRESENTATION LEARNING FOR VIDEO GENERATION

(71) Applicant: Lemon Inc., Grand Cayman (KY)

(72) Inventors: Chenxu ZHANG, Los Angeles, CA (US); Chao Wang, Los Angeles, CA (US); Linjie Luo, Los Angeles, CA (US)

(21) Appl. No.: 18/598,883

(22) Filed: Mar. 7, 2024

Related U.S. Application Data
(60) Provisional application No. 63/614,573, filed on Dec. 23, 2023.

(51) Int. Cl. G06V 10/30; G06V 10/75

(52) U.S. Cl. CPC G06V 10/30; G06V 10/76

(57) ABSTRACT

A method for video generation in machine learning is provided. The method includes encoding an input audio into a plurality of audio features, encoding a first pose state into a first pose feature, constructing a first latent encoding having the audio features and the first pose feature, encoding a second pose state into a second pose feature, constructing a second latent encoding having the audio features and the second pose feature, decoding features in the first latent encoding in to first sequences, decoding features in the second latent encoding in to second sequences, and rendering a video based on the first sequences. The first pose feature, the second pose feature, and each of the audio features respectively corresponds to one frame. The first pose state is different from the second pose state.

### PRIORITY

The present application claims priority to U.S. Provisional Application No. 63/614,573, filed on Dec. 23, 2023 and entitled “DISENTANGLED RECURRENT REPRESENTATION LEARNING FOR EFFICIENT FULL-BODY TALKING VIDEO SYNTHESIS”, the entirety of which is incorporated herein by reference.

### FIELD

The embodiments described herein pertain generally to video generation (e.g., video synthesis, etc.) in machine learning. More specifically, the embodiments described herein pertain to a disentangled recurrent representation learning framework to synthesize long diversified video sequences with a short training video.

### BACKGROUND

Generating realistic human speech video from input audio is a long-standing objective in computer graphics and computer vision with key applications to virtual humans. Some methods utilize heuristics and rules to generate gestures triggered from a predefined audio-to-gesture mapping, which may result in repetitive gestures and a lack of person-specific idiosyncrasies given similar input audio.

Current audio-driven talking video synthesis methods may face significant limitations. In practice, collecting extensive data for specific actors may be challenging, and monotonous training data may lead to a lack of gesture diversity.

### SUMMARY

Features in the embodiments disclosed herein may provide a solution to address the challenge of generating long-term, diverse speech videos using short-term training data. Features in the embodiments disclosed herein may provide a disentangled recurrent representation learning mechanism, which may depart from traditional machine learning models that embed or encode audio and poses into a unified latent space with a “one-to-one” mapping. Instead, features in the embodiments disclosed herein may disentangle the learning of audio and poses, using one initial pose and the audio input as guidance, allowing the neural network to separate audio and pose features.

Features in the embodiments disclosed herein may provide a state bank of varied initial poses to foster “one-to-many” mapping diversity. Features in the embodiments disclosed herein may also provide a recurrent inference or testing module, enabling the generation (e.g., synthesis, etc.) of extended sequences, thereby overcoming the limitations of existing machine learning models in terms of data efficiency and sequence diversity. The effectiveness of the features in the embodiments disclosed herein may be demonstrated by comprehensive evaluations on both existing and customized datasets.

Features in the embodiments disclosed herein may provide “one-to-many” mapping of audio-to-gestures, and generated videos with fragmented, repetitive, or discontinuous sequences in longer videos may be avoided. Features in the embodiments disclosed herein may provide an efficient and versatile generation (e.g., synthesis, etc.) model that may generate a video with (1) the need of much small amount of training data compared with existing models, (2) but showing more diversity of poses and/or gestures in long sequence video generation.

In one example embodiment, a method for video generation in machine learning is provided. The method includes encoding an input audio into a plurality of audio features, encoding a first pose state into a first pose feature, constructing a first latent encoding having the audio features and the first pose feature, encoding a second pose state into a second pose feature, constructing a second latent encoding having the audio features and the second pose feature, decoding features in the first latent encoding in to first sequences, decoding features in the second latent encoding in to second sequences, and rendering a video based on the first sequences. The first pose feature, the second pose feature, and each of the audio features respectively corresponds to one frame. The first pose state is different from the second pose state.

In another example embodiment, a video generation system in machine learning is provided. The system includes a processor and a memory to store an input audio. The processor is to encode the input audio into a plurality of audio features, encode a first pose state into a first pose feature, construct a first latent encoding having the audio features and the first pose feature, encode a second pose state into a second pose feature, construct a second latent encoding having the audio features and the second pose feature, decode features in the first latent encoding in to first sequences, decode features in the second latent encoding in to second sequences, and render a video based on the first sequences. The first pose feature, the second pose feature, and each of the audio features respectively corresponds to one frame. The first pose state is different from the second pose state.

In yet another example embodiment, a non-transitory computer-readable medium having computer-executable instructions stored thereon is provided. The instructions, upon execution, cause one or more processors to perform operations including encoding an input audio into a plurality of audio features, encoding a first pose state into a first pose feature, constructing a first latent encoding having the audio features and the first pose feature, encoding a second pose state into a second pose feature, constructing a second latent encoding having the audio features and the second pose feature, decoding features in the first latent encoding in to first sequences, decoding features in the second latent encoding in to second sequences, and rendering a video based on the first sequences. The first pose feature, the second pose feature, and each of the audio features respectively corresponds to one frame. The first pose state is different from the second pose state.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Non-limiting and non-exhaustive descriptions are described with reference to the following drawings. The components in the figures are not necessarily to scale, emphasis instead being placed upon illustrating principles. In the detailed description that follows, embodiments are described as illustrations only since various changes and modifications may become apparent to those skilled in the art from the following detailed description.

FIG. 1 is a schematic view of an example video generation system, arranged in accordance with at least some embodiments described herein.

FIG. 2 illustrates an example process of synthesizing a video using a disentangled recurrent representation learning framework, in accordance with at least some embodiments described herein.

FIG. 3 illustrates another example process of synthesizing a video using a disentangled recurrent representation learning framework, in accordance with at least some embodiments described herein.

FIG. 4 is a flow chart illustrating an example processing flow for video generation using a disentangled recurrent representation learning framework, in accordance with at least some embodiments described herein.

FIG. 5 illustrates a comparison of video generation between using the disentangled recurrent representation learning framework and using another method, in accordance with at least some embodiments described herein.

FIG. 6 is a schematic structural diagram of an example computer system applicable to implementing an electronic device, arranged in accordance with at least some embodiments described herein.

### DETAILED DESCRIPTION

In the following detailed description, particular embodiments of the present disclosure are described herein with reference to the accompanying drawings, which form a part of the description. In this description, as well as in the drawings, like-referenced numbers represent elements that may perform the same, similar, or equivalent functions, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not intended to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

It is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

Additionally, the present disclosure may be described herein in terms of functional block components and various processing steps. It should be appreciated that such functional blocks may be realized by any number of hardware and/or software components configured to perform the specified functions.

The scope of the disclosure should be determined by the appended claims and their legal equivalents, rather than by the examples given herein. For example, the steps recited in any method claims may be executed in any order and are not limited to the order presented in the claims. Moreover, no element is essential to the practice of the disclosure unless specifically described herein as “critical” or “essential”.

As referenced herein, a “video” may refer to a form of recording and/or broadcasting of moving visual images with an audio component. A “frame” may refer to one of a plurality of still images which compose the moving visual images (or the video). It is to be understood that a frame, in a video context, may refer to a single still image that, when played in sequence with the other frames of the video, may create motion on a playback surface. It is also to be understood that a typical standard definition video may capture about 25, 30, 60, 120, or any other suitable number of frames per second. It is further to be understood that a video may include a plurality of video clips, each video clip may have a length (of e.g., four seconds, etc.). In an example embodiment, a video clip (e.g., a four-second video clip, etc.) may include 128 frames.

As referenced herein, a “pose” or “spatial pose” is a term of art in the fields of computer vision that may refer to the position and orientation of an object, usually in three dimensions. It is to be understood that a “gesture” may refer to a form of non-verbal and/or non-vocal communication in which visible bodily actions may communicate particular messages, either in place of, or in conjunction with, e.g., speech, audio, talk, etc. It is also to be understood that gestures may include movement of the face, hands, and/or other parts of the body. It is further to be understood that a “pose gesture” may refer to a pose including a facial expression, a hand gesture, and a body (e.g., other parts of the body excluding the face and the hand(s)) gesture. Also, it is to be understood that in some embodiments, a “pose gesture” may be used to refer to a pose including a hand gesture and a body (e.g., other parts of the body excluding the face and the hand(s)) gesture, where the facial expression is independent to the pose gesture.

As referenced herein, a “pose state” may refer to a pose or a pose gesture in a frame of a video or video clip.

As referenced herein, a “model” or “framework” may refer to software, such as algorithms and/or programs, hardware or firmware, or any combination thereof that supports machine learning, natural language understanding, natural language processing, speech recognition, computer vision, etc.

As referenced herein, “training” or a training phase in machine learning is a term of art that may refer to feeding or inputting data (e.g., curated data such as training data or datasets, etc.) into a machine learning model (created or generated for an application) so that the model may discover and learn patterns (e.g., learn things it needs to about the type of data the model may analyze).

As referenced herein, “testing” or a testing phase in machine learning is a term of art that may refer to feeding or inputting data (e.g., example data or datasets unseen to the model, etc.) into a machine learning model to validate the model and/or to measure or validate the accuracy of the model.

As referenced herein, “inference”, “inferencing”, or an inference phase in machine learning is a term of art that may refer to a phase where after the machine learning model is trained (and/or tested and/or deployed), the model is to make predictions based on live data or dataset to produce actionable results or outputs.

It is to be understood that in some example embodiments, training and testing may be considered as a “training/testing” phase so that the machine learning model is trained and/or tested before being deployed for the inference phase (e.g., to make predictions). In some example embodiments, during the testing phase, the machine learning model may made predictions to produce actionable results or outputs (similar to the inference phase).

As referenced herein, an “encoder” in machine learning is a term of art that may refer to one or more components or modules that are designed, programmed, or otherwise configured to receive input data and to learn or convert or extract representation (e.g., compressed representation such as features, vectors, feature vectors, etc.) from the input data. It is to be understood that “encode” or “encoding” may refer to the actions (e.g., learning or extracting representation from received input data, etc.) of the encoder.

As referenced herein, an “decoder” in machine learning is a term of art that may refer to one or more components or modules that are designed, programmed, or otherwise configured to convert or reconstruct the representation (e.g., extracted by the encoder) into the output sequence. It is to be understood that “decode” or “decoding” may refer to the actions (e.g., converting or reconstructing the extracted representation, etc.) of the decoder.

It is to be understood that encoder and decoder are machine translation methods, where the encoder may convert the input sequence into features, vectors, feature vectors, etc., and the decoder may convert the features, vectors, feature vectors, etc. into the output sequence. It is also to be understood that the features, vectors, feature vectors, etc. may correspond to “latent features” in a “latent space”. Non-limiting examples of the extracted features may include surfaces, gender, skin color, lighting, coloring, identities, motion, animals, objects, edges, points, boundaries, curves, shapes, etc. As referenced herein, a “latent space” may refer to a latent feature space, an encoding space, or an embedding space in which items resembling each other more closely are positioned close to one another.

As referenced herein, “rendering” or “neural rendering” in machine learning is a term of art that may refer to a class of image and/or video generation approaches that enable explicit or implicit control of scene properties such as illumination or lighting, camera parameters, pose, geometry, appearance, shapes, semantic structure, etc. It is to be understood that “rendering” or “neural rendering” may refer to a method, based on deep neural networks and physics engines, which can create novel images and/or video footage based on existing scenes. It is also to be understood that the functions of “rendering” or “neural rendering” may be implemented by a “renderer” or “neural renderer”.

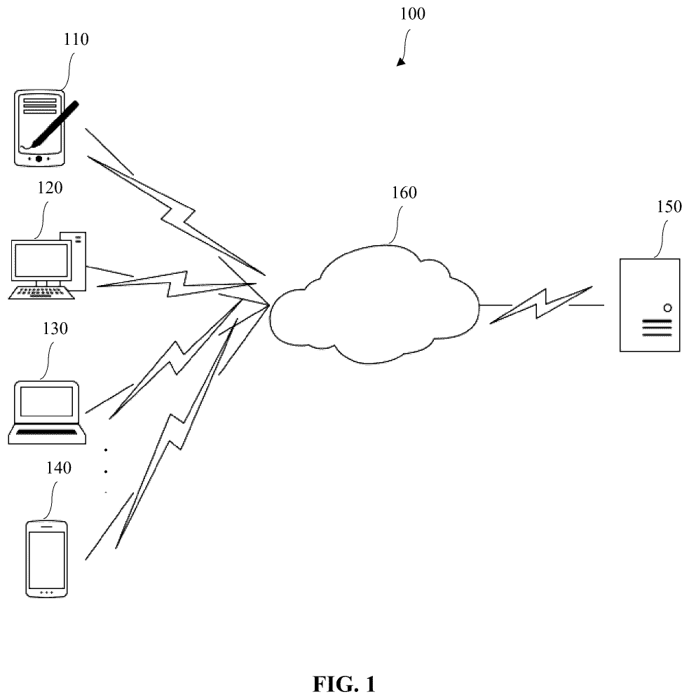

FIG. 1 is a schematic view of an example video generation (e.g., video synthesis, etc.) system 100 (e.g., a full-body talking video synthesis system), arranged in accordance with at least some embodiments described herein.

The system 100 may include terminal devices 110, 120, 130, and 140, a network 160, and/or a server 150. It is to be understood that the server 150 may be a video synthesis server that provides video synthesis services to other computer programs or to computers, as defined by e.g., a client-server model. The terminal devices 110, 120, 130, and 140 may be the device(s) used to request the video synthesis services from the server. It is also to be understood that FIG. 1 only shows illustrative numbers of the terminal devices, the network, and the server. The embodiments described herein are not limited to the number of the terminal devices, the network, and/or the server described. That is, the number of terminal devices, networks, and/or servers described herein are provided for descriptive purposes only and are not intended to be limiting.

In accordance with at least some example embodiments, the terminal devices 110, 120, 130, and 140 may be various electronic devices. The various electronic devices may include but not be limited to a mobile device such as a smartphone, a tablet computer, an e-book reader, a laptop computer, a desktop computer, and/or any other suitable electronic devices.

In accordance with at least some example embodiments, the network 160 may be a medium used to provide a communications link between the terminal devices 110, 120, 130, 140 and the server 150. The network 160 may be the Internet, a local area network (LAN), a wide area network (WAN), a local interconnect network (LIN), a cloud, etc. The network 160 may be implemented by various types of connections, such as a wired communications link, a wireless communications link, an optical fiber cable, etc.

In accordance with at least some example embodiments, the server 150 may be a server for providing various services to users using one or more of the terminal devices 110, 120, 130, and 140. The server 150 may be implemented by a distributed server cluster including multiple servers or may be implemented by a single server.

A user may use one or more of the terminal devices 110, 120, 130, and 140 to interact with the server 150 via the network 160. Various applications or localized interfaces thereof, such as social media applications, online shopping applications, or the like, may be installed on the terminal devices 110, 120, 130, and 140.

It is to be understood that software applications or services according to the embodiments described herein and/or according to the services provided by the service providers may be performed by the server 150 and/or the terminal devices 110, 120, 130, and 140 (which may be referred to herein as user devices). Accordingly, the apparatus for the software applications and/or services may be arranged in the server 150 and/or in the terminal devices 110, 120, 130, and 140.

It is also to be understood that when a service is not performed remotely, the system 100 may optionally include the network 160 while including the terminal device 110, 120, 130, and 140, or the server 150.

It is further to be understood that the terminal device 110, 120, 130, and 140 and the server 150 may each include one or more processors, a memory, and a storage device storing one or more programs. Each of the terminal device 110, 120, 130, and 140 and/or the server 150 may also each include an Ethernet connector, a wireless fidelity receptor, etc. The one or more programs, when being executed by the one or more processors, may cause the one or more processors to perform the method(s) described in any embodiments described herein. Also, it is to be understood that a computer readable non-volatile medium and/or non-transitory may be provided according to the embodiments described herein. The computer readable medium stores computer programs. The computer programs are used to, when being executed by a processor, perform the method(s) described in any embodiments described herein.

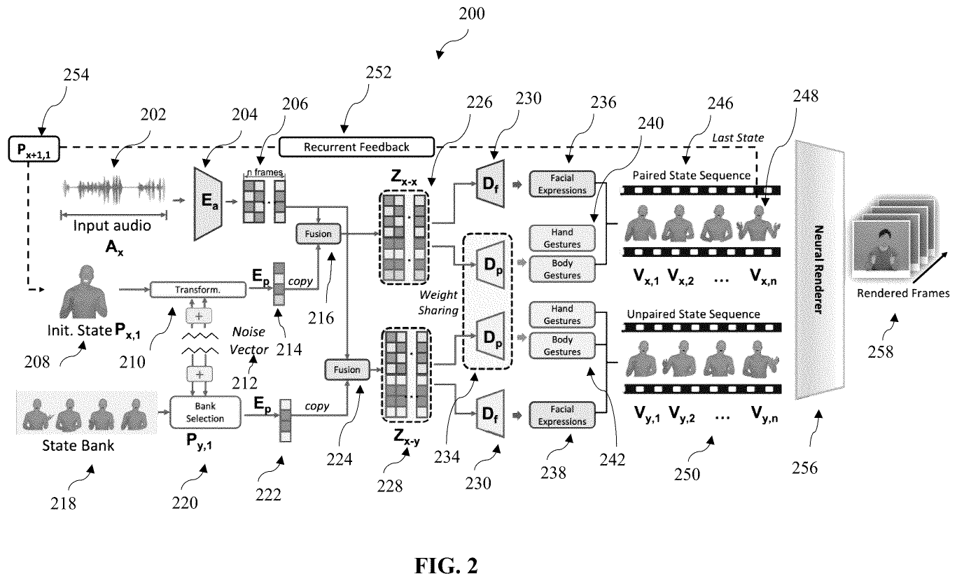

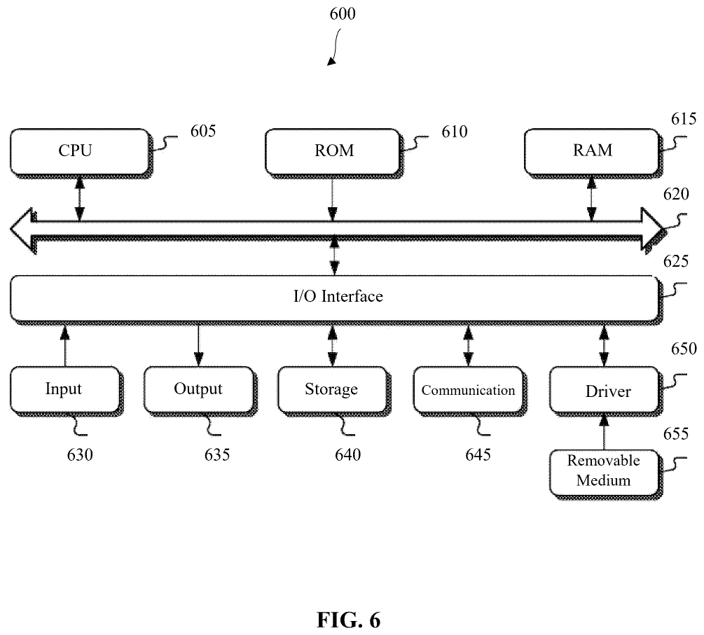

FIG. 2 illustrates an example process 200 of synthesizing a video using a disentangled recurrent representation learning framework, in accordance with at least some embodiments described herein. It is to be understood that the processes disclosed herein can be conducted by one or more processors (e.g., the processor of one or more of the terminal device 110, 120, 130, and 140 of FIG. 1, the processor of the server 150 of FIG. 1, the central processor unit 605 of FIG. 6, and/or any other suitable processor), unless otherwise specified. It is also to be understood that the components or modules described herein are part of the disentangled recurrent representation learning framework, unless otherwise specified.

In an example embodiment, a video (or a video sequence, a video space, etc.) V may be used as the training data to train a framework (or a machine learning model, e.g., the disentangled recurrent representation learning framework, etc.) described herein. The video may be a short video having a length of at or about two minutes, a short video having a length of less than two minutes, etc. The video may include a plurality of video clips (V₁, V₂ . . . Vₓ . . . Vₘ). Each video clip has a length (e.g., four seconds, etc.) and includes a plurality of frames (e.g., n frames such as 128 frames, etc.). Each video clip (Vₓ) includes an audio component or state (Aₓ) and a pose gesture component or state (Pₓ). Each audio component (Aₓ) may include a plurality of audio states (A_{x, I}, where i ranges from 1 to n, and n is the number of frames in the video clip). Each pose gesture component (Pₓ) may include a plurality of pose states (P_{x, i}, where i ranges from 1 to n). It is to be understood that each audio state may include the audio information (e.g., audio parameters, etc.) corresponding to the respective frame. Each pose state may include the pose gesture information (e.g., pose gesture parameters, etc.) corresponding to the respective frame.

As shown in FIG. 2, in the disentangled recurrent representation learning framework, the process 200 may begin with a first process stream with an input audio 202 (e.g., Aₓ) and an initial pose state 208 (e.g., P_{x,1}), to e.g., guide or supervise the machine learning model or framework. The input audio Aₓ may be fed into an audio encoder 204 so that the audio encoder 204 may convert the input audio 202 into a plurality of audio features 206. It is to be understood that the input audio 202 (Aₓ) may include a plurality of audio states corresponding to the frames of the video clip (Vₓ), and each converted audio feature may correspond to a respective frame in the video clip (Vₓ). The initial pose state 208 (e.g., P_{x,1}) may be a single pose state correspond to one frame of the video clip (Vₓ), and the converted pose feature 214 may correspond to one frame of in the video clip (Vₓ). It is to be understood that the input audio 202 may be audio of a user, or another audio source, and/or the combination thereof, etc.

In an example embodiment, the initial pose state 208 (e.g., P_{x,1}) may be fed into a pose encoder 210 so that the pose encoder 210 may convert the initial pose state 208 into a pose feature 214. Optionally, a first noise (e.g., a noise vector, a random noise, etc.) 212 may be applied to the initial pose state 208 before the initial pose state 208 being fed into the pose encoder 210.

In an example embodiment, the pose feature 214 may be copied into n pose features, where n is the number of frames in the video clip (Vₓ), e.g., to match the matrix size of the pose feature(s) 214 to the matrix size of the audio features 206. It is to be understood that the wording “copy” is a non-limiting example, and it may be any suitable method of copy, duplicate, duplicate a partial thereof, repetition, adding, and/or inserting, etc., the data (e.g., the pose feature 214) itself and/or similar or different data.

In an example embodiment, each of the audio features 206 may be fused (e.g., concatenated, etc., see the fusion module 216) with each of the copied pose features 214, to form a latent encoding 226 (e.g., Zₓ₋ₓ) in a latent space. As shown (e.g., via the shading pattern) in the latent encoding 226 (e.g., Zₓ₋ₓ), each fused/concatenated feature include one converted audio feature (of the plurality of audio features 206) and one pose feature 214 (or a copy of the pose features 214). It is to be understood that the latent encoding 226 (e.g., Zₓ₋ₓ) in a latent space may be a paired (with the input audio) encoding of the face (e.g., facial expression), the hand (e.g., hand gesture), and the body (e.g., body gesture), establishing e.g., a supervision to the machine learning model or framework. It is also to be understood that since the input audio 202 (Aₓ) and the initial pose state 208 (e.g., P_{x,1}) are from a same video clip, the latent encoding 226 (e.g., Zₓ₋ₓ) in the latent space is referred to as “paired” latent encoding.

It is to be understood that in the first process stream, in some embodiments, only the initial pose state 208 (e.g., P_{x,1}) is used as initial input while leaving the framework an imagined space to fill in the subsequent ones P_{x,2:n}.

In an example embodiment, in a second process stream, a state bank 218 having a plurality of pose states (e.g., initial pose states) may be obtained, received, provided, or constructed from unpaired pose states (e.g., from the video space V). For example, an initial pose state 220 (e.g., P_{y,1}), which is a single pose state correspond to one frame of the video clip (V_{y}) of the video space V, may be selected (e.g., randomly selected) from the state bank 218. It is also to be understood that the initial pose state 220 (e.g., P_{y,1}) is from a video clip V_{y} that is different from the video clip Vₓ having the initial pose state 208 (e.g., P_{x,1}), the initial pose state 220 (e.g., P_{y,1}) is thus different from the initial pose state 208 (e.g., P_{x,1}).

In an example embodiment, the initial pose state 220 (e.g., P_{y,1}) may be fed into a pose encoder so that the pose encoder may convert the initial pose state 220 into a pose feature 222. A second noise (e.g., a noise vector, a random noise, etc.) 212 may be applied to the initial pose state 220 before the initial pose state 220 being fed into the pose encoder. It is to be understood that the second noise 212 may be the same as or independent to the first noise 212. In an example embodiment, the pose feature 222 may be copied into n pose features, where n is the number of frames in the video clip (Vₓ or V_{y}). It is to be understood that the wording “copy” is a non-limiting example, and it may be any suitable method of copy, duplicate, duplicate a partial thereof, repetition, adding, and/or inserting, etc., the data (e.g., the pose feature 222) itself and/or similar or different data.

In an example embodiment, each of the audio features 206 may be fused (e.g., concatenated, etc., see the fusion module 224) with each of the copied pose features 222, to form a latent encoding 228 (e.g., Z_{x-y}) in a latent space. As shown (e.g., via the shading pattern) in the latent encoding 228 (e.g., Z_{x-y}), each fused/concatenated feature include one converted audio feature (of the plurality of audio features 206) and one pose feature 222 (or a copy of the pose features 222). It is to be understood that the latent encoding 228 (e.g., Z_{x-y}) in a latent space may be an unpaired (with the input audio) encoding of the face (e.g., facial expression), the hand (e.g., hand gesture), and the body (e.g., body gesture). It is also to be understood that since the input audio 202 (Aₓ) and the initial pose state 220 (e.g., P_{y,1}) are from a different video clip, the latent encoding 228 (e.g., Z_{x-y}) in the latent space is referred to as “unpaired” latent encoding. That is, the framework processes the same audio sample Aₓ but pairs it with a different initial pose state P_{y,1}, leading to an unpaired generation.

It is to be understood that the dual-stream (the first process stream and the second process stream) process approach described herein may foster diversity in output. It is also to be understood that the first process stream and the second process stream may be performed in parallel. Traditional process may require a long sequence of training data with similar identities, and may lead to overfitting due to the strong prior encoded by the gesture sequences. Since in the gesture generation of speech video synthesis, one may perform different gestures with the same speech content (e.g., audio), learning a strict one-to-one mapping may encounter challenges, especially when there is no sufficient data collected. Features in the embodiments disclosed herein may provide a disentangled latent space (one-to-many mapping) for gesture and audio combinations to embed or encode the loose correlation.

In an example embodiment, the encoded feature such as the latent encoding 226 (e.g., Zₓ₋ₓ) and/or the latent encoding 228 (e.g., Z_{x-y}) may be decoded separately by two decoders: the pose decoder Dₚ 234 to generate hand and body gestures (240 and/or 242), and the face decoder D_{f} 230 to generate facial expressions (236 and/or 238). It is to be understood that a same pose decoder Dₚ 234 (e.g., a weight-sharing pose decoder) and/or a same face decoder D_{f} 230 may be used for the paired latent encoding 226 (e.g., Zₓ₋ₓ) and the unpaired latent encoding 228 (e.g., Z_{x-y}), to loose the coupling of the audio and gesture from the same video frame while encouraging the diversity of poses in the video space V.

In an example embodiment, the decoded facial expressions 236 and the decoded hand and body gestures 240 from the paired latent encoding 226 (e.g., Zₓ₋ₓ) may form the paired state sequences 246 (e.g., having n video frames V_{x,1}, V_{x,2}, . . . V_{x,n}, each having an audio state and a pose state). The decoded facial expressions 238 and the decoded hand and body gestures 242 from the unpaired latent encoding 228 (e.g., Z_{x-y}) may form the unpaired state sequences 250 (e.g., having n video frames V_{y,1}, V_{y,2}, . . . V_{y,n}, each having an audio state and a pose state).

In an example embodiment, the paired state sequences 246 and the unpaired state sequences 250 may be fed as input to a neural renderer 256 to generate the rendered frames 258 (e.g., the output video).

It is also to be understood that the general appearance (e.g., body and hand gestures) may show a strict correlation with the initial pose state, while the gestures' movements may have a relatively high correlation with the audio input, to encourage diversity. Under a limitation of short training data (at or about or less than two minutes, which may be less than 1/30 of typical datasets), the disentangled representation learning disclosed herein may be designed with the features such as (i) not inputting a full pose sequence of n frames but only the initial frame to encourage the strict correlation with initial pose, (ii) loosing the coupling of audio and pose and use the unpaired training to enhance the diversity of poses, and (iii) the random noises 212 being used to add a slight perturbation for initial states while still maintaining them in a reasonable range.

In an example embodiment, during the inference and/or testing phase, for the first process stream, the framework disclosed herein may provide a feedback loop. The feedback loop process may take the last pose state 248 P_{x,n} (from the last paired state sequence (V_{x,n}) from the current generation/iteration), which is a part of the video sequence V_{x,n}, and may use the last pose state 248 (as the recurrent feedback 252 and) as the initial pose state 254 P_{x+1,1} for the next generation/iteration (e.g., to replace the pose state 208 P_{x,1}). It is to be understood that the recurrent mechanism may ensure continuity and coherency in longer sequences, enabling the synthesis of extended and diverse gesture sequences while relying on minimal initial data. It is also to be understood that the recurrent mechanism in the first process stream may only for the inference and/or testing phase. It is further to be understood that the second process stream may only for the training phase. It is to be understood that the processes described above may be repeated until all input audio Aₓ (x ranges from 1 to m, where m is the number of video clips in the video space V) of all video clips in the training video V (e.g., at or about or less than two minutes), and/or all input audio Aₓ (each Aₓ is at or about or less than four seconds, and the input audio may be arbitrarily long for inference and/or testing) are processed. In an example embodiment, the feedback loop process may take the any suitable pose state (e.g., from the paired state sequence from the current generation/iteration), and may use such pose state as the initial pose state P_{x+1,1} for the next generation/iteration (e.g., to replace the pose state 208 P_{x,1}).

It is to be understood that the framework described herein provides the recurrent inference for arbitrarily-long sequences. It is also to be understood that existing mechanisms may encounter challenges when encoding and generating long-term diverse sequences, such as (i) input pose sequences strictly constraining the generation results to be similar, which may make them hard to generalize, and (ii) the generated sequence being difficult to guarantee the continuity between two adjacent clips since they are generated separately. With the recurrent scheme described herein, the generated ending pose of the current clip may be used as an initial guidance and gesture template of the next clip, and the random noise (e.g., the first noise 212) is removed for sequences continuity during the inference stage. Thus, the framework described herein may generate arbitrarily-long diverse video sequences. In addition, as the framework only encodes the pose of first frame as guidance, the generated video may show rich pose diversity.

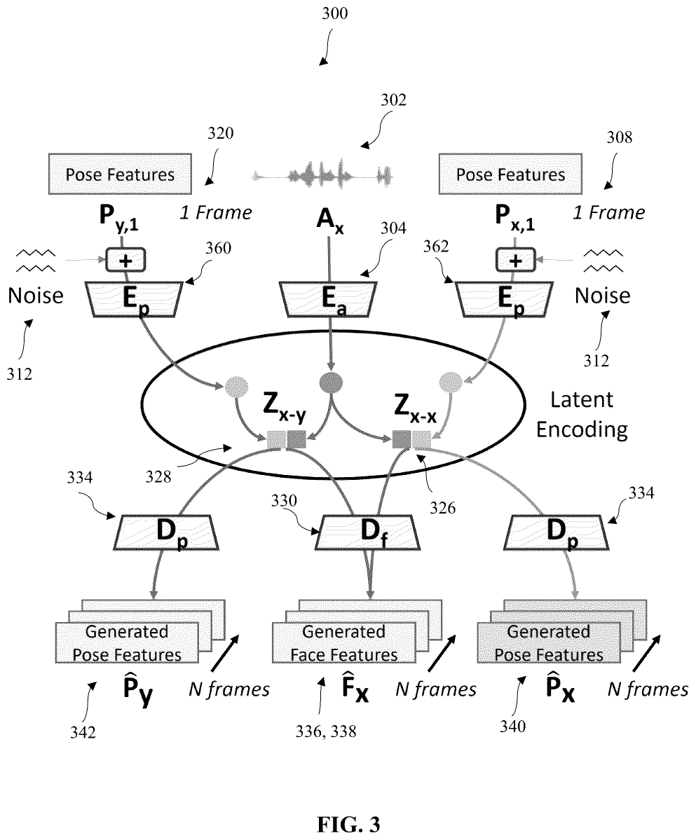

FIG. 3 illustrates another example process 300 of synthesizing a video using a disentangled recurrent representation learning framework, in accordance with at least some embodiments described herein. It is to be understood that the process 300 may be the same as the process 200 of FIG. 2 and that like reference numbers represent like parts throughout. It is also to be understood that the feedback loop is not shown in process 300.

As shown in FIG. 3, in the disentangled recurrent representation learning framework, the process 300 may begin with a first process stream with an input audio 302 (e.g., Aₓ) and an initial pose state 308 (e.g., P_{x,1}, from a plurality of pose gestures Pₓ), to e.g., guide or supervise the machine learning model or framework. The input audio Aₓ may be fed into an audio encoder 304 so that the audio encoder 304 may convert the input audio 302 into a plurality of audio features. It is to be understood that the input audio 302 (Aₓ) may include a plurality of audio states corresponding to the frames of the video clip (Vₓ), and each converted audio feature may correspond to a respective frame in the video clip (Vₓ). The initial pose state 308 (e.g., P_{x,1}) may be a single pose state correspond to one frame of the video clip (Vₓ), and the converted pose feature may correspond to one frame of in the video clip (Vₓ). It is to be understood that the input audio 302 may be audio of a user, or another audio source, and/or the combination thereof, etc.

In an example embodiment, the initial pose state 308 (e.g., P_{x,1}) may be fed into a pose encoder 362 so that the pose encoder 362 may convert the initial pose state 308 into a pose feature. Optionally, a first noise (e.g., a noise vector, a random noise, etc.) 312 may be applied to the initial pose state 308 before the initial pose state 308 being fed into the pose encoder 362.

In an example embodiment, the pose feature may be copied into n pose features, where n is the number of frames in the video clip (Vₓ). It is to be understood that the wording “copy” is a non-limiting example, and it may be any suitable method of copy, duplicate, duplicate a partial thereof, repetition, adding, and/or inserting, etc., the data (e.g., the pose feature) itself and/or similar or different data.

In an example embodiment, each of the audio features may be fused (e.g., concatenated, etc.) with each of the copied pose features, to form a latent encoding 326 (e.g., Zₓ₋ₓ) in a latent space. As shown (e.g., via the shading) in the latent encoding 326 (e.g., Zₓ₋ₓ), each fused/concatenated feature include one converted audio feature (of the plurality of audio features) and one pose feature (or a copy of the pose features). It is to be understood that the latent encoding 326 (e.g., Zₓ₋ₓ) in a latent space may be a paired (with the input audio) encoding of the face (e.g., facial expression), the hand (e.g., hand gesture), and the body (e.g., body gesture), establishing e.g., a supervision to the machine learning model or framework. It is also to be understood that since the input audio 302 (Aₓ) and the initial pose state 308 (e.g., P_{x,1}) are from a same video clip, the latent encoding 326 (e.g., Zₓ₋ₓ) in the latent space is referred to as “paired” latent encoding.

It is to be understood that in the first process stream, only the initial pose state 308 (e.g., P_{x,1}) is used as initial input while leaving the framework an imagined space to fill in the subsequent ones P_{x,2:n}.

In an example embodiment, in a second process stream, a state bank having a plurality of pose states (e.g., initial pose states) may be obtained, received, provided, or constructed from unpaired pose states. For example, an initial pose state 320 (e.g., P_{y,1}), which is a single pose state correspond to one frame of the video clip (V_{y}), may be selected from the state bank. It is also to be understood that the initial pose state 320 (e.g., P_{y,1}) is from a video clip V_{y} that is different from the video clip Vₓ having the initial pose state 308 (e.g., P_{x,1}), the initial pose state 320 (e.g., P_{y,1}) is thus different from the initial pose state 308 (e.g., P_{x,1}).

In an example embodiment, the initial pose state 320 (e.g., P_{y,1}) may be fed into a pose encoder 360 so that the pose encoder 360 may convert the initial pose state 320 into a pose feature. A second noise (e.g., a noise vector, a random noise, etc.) 312 may be applied to the initial pose state 320 before the initial pose state 320 being fed into the pose encoder. It is to be understood that the second noise 312 may be the same as or independent to the first noise 312. In an example embodiment, the pose feature may be copied into n pose features, where n is the number of frames in the video clip (Vₓ or V_{y}). It is to be understood that the wording “copy” is a non-limiting example, and it may be any suitable method of copy, duplicate, duplicate a partial thereof, repetition, adding, and/or inserting, etc., the data (e.g., the pose feature) itself and/or similar or different data.

In an example embodiment, each of the audio features may be fused (e.g., concatenated, etc.) with each of the copied pose features, to form a latent encoding 328 (e.g., Z_{x-y}) in a latent space. As shown (e.g., via the shading) in the latent encoding 328 (e.g., Z_{x-y}), each fused/concatenated feature include one converted audio feature (of the plurality of audio features) and one pose feature (or a copy of the pose features). It is to be understood that the latent encoding 328 (e.g., Z_{x-y}) in a latent space may be an unpaired (with the input audio) encoding of the face (e.g., facial expression), the hand (e.g., hand gesture), and the body (e.g., body gesture). It is also to be understood that since the input audio 302 (Aₓ) and the initial pose state 320 (e.g., P_{y,1}) are from a different video clip, the latent encoding 328 (e.g., Z_{x-y}) in the latent space is referred to as “unpaired” latent encoding. That is, the framework processes the same audio sample Aₓ but pairs it with a different initial pose state P_{y,1}, leading to an unpaired generation.

It is to be understood that the dual-stream (the first process stream and the second process stream) process approach described herein may foster diversity in output. Traditional process may require a long sequence of training data with similar identities, and may lead to overfitting due to the strong prior encoded by the gesture sequences. Since in the gesture generation of speech video synthesis, one may perform different gestures with the same speech content (e.g., audio), learning a strict one-to-one mapping may encounter challenges, especially when there is no sufficient data collected. Features in the embodiments disclosed herein may provide a disentangled latent space (one-to-many mapping) for gesture and audio combinations to embed or encode the loose correlation.

In an example embodiment, the encoded feature such as the latent encoding 326 (e.g., Zₓ₋ₓ) and/or the latent encoding 328 (e.g., Z_{x-y}) may be decoded separately by two decoders: the pose decoder Dₚ 334 to generate pose features 340 and/or 342 (e.g., hand and body gestures), and the face decoder D_{f} 330 to generate facial expressions (336 and/or 338). It is to be understood that a same pose decoder Dₚ 334 (e.g., a weight-sharing pose decoder) and/or a same face decoder D_{f} 330 may be used for the paired latent encoding 326 (e.g., Zₓ₋ₓ) and the unpaired latent encoding 328 (e.g., Z_{x-y}), to loose the coupling of the audio and gesture from the same video frame while encouraging the diversity of poses in the video space V.

In an example embodiment, the decoded facial expressions 336 (e.g., corresponding to n frames) and the decoded pose features 340 (e.g., hand and body gestures corresponding to n frames) from the paired latent encoding 326 (e.g., Zₓ₋ₓ) may form the paired state sequences (e.g., having n video frames each having an audio state and a pose state). The decoded facial expressions 338 (e.g., corresponding to n frames) and the decoded pose features 342 (e.g., hand and body gestures corresponding to n frames) from the unpaired latent encoding 328 (e.g., Z_{x-y}) may form the unpaired state sequences (e.g., having n video frames each having an audio state and a pose state). It is to be understood that the decoded facial expressions 336 and the decoded facial expressions 338 may be decoded or determined following similar constraints but with a different input, and both indicate strong correlations of face and audio.

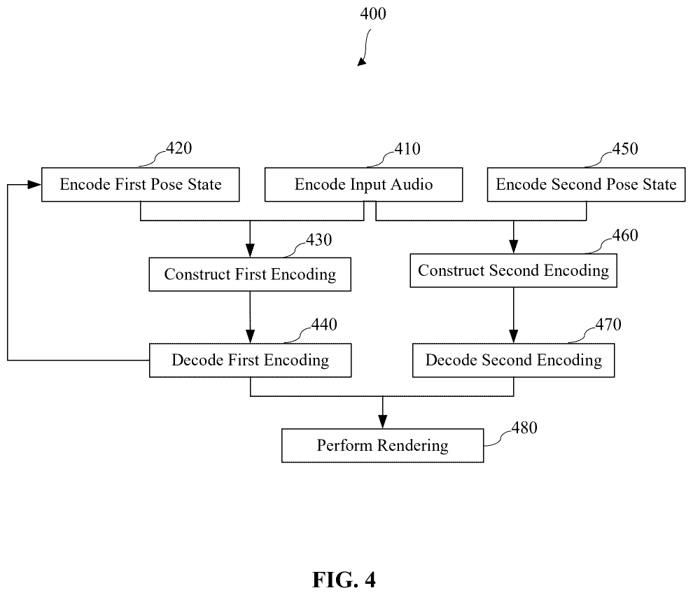

FIG. 4 is a flow chart illustrating an example processing flow 400 for video generation (e.g., video synthesis, etc.) using a disentangled recurrent representation learning framework, in accordance with at least some embodiments described herein.

It is to be understood that the processing flow 400 disclosed herein can be conducted by one or more processors (e.g., the processor of one or more of the terminal device 110, 120, 130, and 140 of FIG. 1, the processor of the server 150 of FIG. 1, the central processor unit 605 of FIG. 6, and/or any other suitable processor), unless otherwise specified.

It is also to be understood that the processing flow 400 can include one or more operations, actions, or functions as illustrated by one or more of blocks 410, 420, 430, 440, 450, 460, 470, and 480. These various operations, functions, or actions may, for example, correspond to software, program code, or program instructions executable by a processor that causes the functions to be performed. Although illustrated as discrete blocks, obvious modifications may be made, e.g., two or more of the blocks may be re-ordered; further blocks may be added; and various blocks may be divided into additional blocks, combined into fewer blocks, or eliminated, depending on the desired implementation. It is to be understood that before the processing flow 400, operations including initializations or the like may be performed. For example, system parameters and/or application parameters may be initialized. It is to be understood that the processes, operations, or actions described in FIGS. 2 and 3 may be implemented or performed by the processor. Processing flow 400 may begin at block 410, block 420, or block 450. In an example embodiment, the processor may perform a first process stream (Blocks 410, 420, 430, 440) in parallel to performing a second process stream (Blocks 410, 450, 460, 470).

At block 410 (Encode Input Audio), the processor may encode an input audio (e.g., Aₓ) e.g., by running or executing an audio encoder, to convert the input audio into a plurality of audio features. It is to be understood that the input audio (e.g., Aₓ) may include a plurality of audio states corresponding to the number of frames of a video clip (Vₓ) of a video (e.g., a training video during the training phase, the video being at or about or less than two minutes), and each converted audio feature may correspond to a respective frame in the video clip (Vₓ). It is to be understood that the input audio may also be an audio (e.g., with an arbitrary length) for the testing or inference phase (e.g., after the framework or model described herein is trained). It is further to be understood that the input audio may be audio of a user, or another audio source, and/or the combination thereof, etc. Processing may proceed from block 410 to block 430.

At block 420 (Encode First Pose State), the processor may encode an initial pose state (e.g., P_{x,1}) e.g., by running or executing a pose encoder, to convert the initial pose state into a pose feature. It is to be understood that the initial pose state (e.g., P_{x,1}) may be a single pose state correspond to one frame of the video clip (Vₓ) of a video (e.g., the training video), and the converted pose feature may correspond to one frame of in the video clip (Vₓ). In an example embodiment, the processor may optionally apply a first noise (e.g., a noise vector, a random noise, etc.) to the initial pose state before the initial pose state being encoded. It is also to be understood that the processor may apply the first noise only at the first iteration (e.g., the processor may not apply the first noise when the process proceeds from block 440 back to block 420). Processing may proceed from block 420 to block 430.

At block 430 (Construct First Encoding), the processor may copy or duplicate the pose feature (encoded at block 420) into n pose features, where n is the number of frames in the video clip (Vₓ). It is to be understood that the wording “copy” is a non-limiting example, and it may be any suitable method of copy, duplicate, duplicate a partial thereof, repetition, adding, and/or inserting, etc., the data (e.g., the pose feature encoded at block 420) itself and/or similar or different data. In an example embodiment, the processor may fuse or concatenate each of the audio features (encoded at block 410) with each of the copied pose features, to form a latent encoding (e.g., Zₓ₋ₓ) in a latent space. It is to be understood that the formed latent encoding (e.g., Zₓ₋ₓ) in the latent space may be a paired (with the input audio) encoding of the face (e.g., facial expression), the hand (e.g., hand gesture), and the body (e.g., body gesture), establishing e.g., a supervision to the machine learning model or framework. It is also to be understood that since the input audio (Aₓ) and the initial pose state (e.g., P_{x,1}) are from a same video clip, the latent encoding (e.g., Zₓ₋ₓ) in the latent space is referred to as “paired” latent encoding. It is further to be understood that in the first process stream, only the initial pose state (e.g., P_{x,1}) is used as initial input while leaving the framework an imagined space to fill in the subsequent ones P_{x,2:n}. Processing may proceed from block 430 to block 440.

At block 440 (Decode First Encoding), the processor may decode the encoded feature such as the latent encoding (e.g., Zₓ₋ₓ) at block 430 separately e.g., by running or executing two decoders: a pose decoder to generate hand and body gestures, and a face decoder to generate facial expressions. In an example embodiment, the processor may form the paired state sequences (e.g., having n video frames V_{x,1}, V_{x,2}, . . . V_{x,n}, each having an audio state and a pose state) from the decoded facial expressions and the decoded hand and body gestures from the paired latent encoding (e.g., Zₓ₋ₓ). When the phase is a training phase, processing may proceed from block 440 to block 480.

When the phase is a testing or inference phase, the processor may perform a feedback loop (e.g., by proceeding from block 440 to block 420). In an example embodiment, the processor may receive, obtain, or retrieve the last pose state P_{x,n} (from the last paired state sequence (V_{x,n}) from the current generation/iteration), which is a part of the video sequence V_{x,n}, and may use the last pose state as the initial pose state P_{x+1,1} for the next generation/iteration (e.g., to replace the pose state P_{x,1} at block 420). It is to be understood that the recurrent mechanism in the first process stream may only for the inference and/or testing phase. It is further to be understood that the second process stream may only for the training phase. It is to be understood that the first and/or second process streams may be repeated until all input audio Aₓ (x ranges from 1 to m, where m is the number of video clips in the video space V) of all video clips in the training video V (e.g., at or about or less than two minutes), and/or all input audio Aₓ (each Aₓ is at or about or less than four seconds, and the input audio may be arbitrarily long for inference and/or testing) are processed. Processing may proceed from block 440 to block 420.

At block 450 (Encode Second Pose State), the processor may obtain, receive, provide, or construct a state bank having a plurality of pose states (e.g., initial pose states) from unpaired pose states (e.g., from a video clip V_{y} that is different from the video clip Vₓ at block 420). In an example embodiment, the processor may select an initial pose state (e.g., P_{y,1}), which is a single pose state correspond to one frame of the video clip (V_{y}), from the state bank. It is to be understood that the initial pose state (e.g., P_{y,1}) at block 450 is from a video clip V_{y} that is different from the video clip Vₓ having the initial pose state (e.g., P_{x,1}) at block 420, and the initial pose state (e.g., P_{y,1}) at block 450 is thus different from the initial pose state (e.g., P_{x,1}) at block 420. In an example embodiment, the processor may encode the initial pose state (e.g., P_{y,1}) e.g., by running or executing a pose encoder, to convert the initial pose state (e.g., P_{y,1}) into a pose feature. In an example embodiment, the processor may apply second noise (e.g., a noise vector, a random noise, etc.) the initial pose state (e.g., P_{y,1}) before the initial pose state (e.g., P_{y,1}) being encoded. It is to be understood that the second noise may be the same as or independent to the first noise at block 420. Processing may proceed from block 450 to block 460.

At block 460 (Construct First Encoding), the processor may copy or duplicate the pose feature (encoded from block 450) into n pose features, where n is the number of frames in the video clip (Vₓ or V_{y}). It is also to be understood that the wording “copy” is a non-limiting example, and it may be any suitable method of copy, duplicate, duplicate a partial thereof, repetition, adding, and/or inserting, etc., the data (e.g., the pose feature encoded at block 450) itself and/or similar or different data. In an example embodiment, the processor may fuse or concatenate each of the audio features (encoded at block 410) with each of the copied pose features, to form a latent encoding (e.g., Z_{x-y}) in a latent space. It is to be understood that the latent encoding (e.g., Z_{x-y}) in the latent space may be an unpaired (with the input audio) encoding of the face (e.g., facial expression), the hand (e.g., hand gesture), and the body (e.g., body gesture). It is also to be understood that since the input audio (Aₓ) at block 410 and the initial pose state (e.g., P_{y,1}) at block 450 are from a different video clip, the latent encoding (e.g., Z_{x-y}) in the latent space is referred to as “unpaired” latent encoding. That is, in the second process stream, the framework processes the same audio sample Aₓ but pairs it with a different initial pose state P_{y,1} (compared with the initial pose state at the first process stream) leading to an unpaired generation. Processing may proceed from block 460 to block 470.

At block 470 (Decode Second Encoding), the processor may decode the encoded feature such as the latent encoding (e.g., Z_{x-y}) at block 460 separately e.g., by running or executing two decoders: a pose decoder to generate hand and body gestures, and a face decoder to generate facial expressions. It is to be understood that a same pose decoder (e.g., a weight-sharing pose decoder) and/or a same face decoder may be used for the paired latent encoding (e.g., Zₓ₋ₓ) at block 440 and the unpaired latent encoding (e.g., Z_{x-y}) at block 470, to loose the coupling of the audio and gesture from the same video frame while encouraging the diversity of poses in the video space V. In an example embodiment, the processor may form the unpaired state sequences (e.g., having n video frames V_{y,1}, V_{y,2}, . . . V_{y,n}, each having an audio state and a pose state) from the decoded facial expressions and the decoded hand and body gestures from the unpaired latent encoding (e.g., Z_{x-y}). Processing may proceed from block 470 to block 480.

At block 480 (Perform Rendering), the processor may perform the rendering (e.g., neural rendering, etc.) by e.g., by running or executing a renderer (e.g., a neural renderer) on the paired state sequences from block 440 and the unpaired state sequences from the block 470, to generate the rendered frames (e.g., the output video).

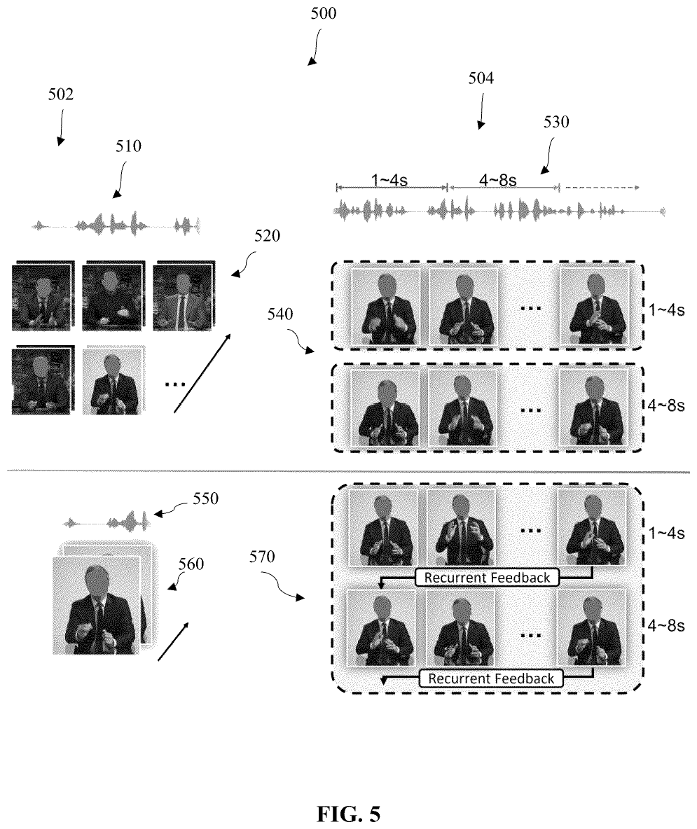

FIG. 5 illustrates a comparison 500 of video generation (e.g., video synthesis, etc.) between using the disentangled recurrent representation learning framework and using another method, in accordance with at least some embodiments described herein.

As shown in FIG. 5, the processes for comparison include a training phase 502 (left portion) and a testing or inference phase 504 (right portion). The top portion shows the video synthesis examples using another method, and the bottom portion shows the video synthesis examples using the disentangled recurrent representation learning framework described herein. A long testing audio 530 (e.g., arbitrarily long input audio) may be provided for the testing or inference phase).

In the top portion of FIG. 5, a long paired sequence 520 (e.g., at or about or greater than 60 minutes, paired with the corresponding audio 510, e.g., of the same actor or multi-actors with similar gestures) may be required as training data in the training phase 502. In the testing or inference phase 504 using the long testing audio 530 as the input, short video fragments (e.g., every four seconds, etc.) may be generated by using another method, resulting in separated video sequences 540.

In the bottom portion of FIG. 5, a short training sequence 560 (e.g., at or about or less than two minutes, having the audio 550) may be used as training data in the training phase 502. In the testing or inference phase 504 using the long testing audio 530 as the input, “endless” video sequences 570 (e.g., continuous with recurrent feedback, etc.) having high diversity and continuity may be generated by using the disentangled recurrent representation learning framework described herein.

Features in the embodiments disclosed herein may provide a disentangled recurrent representation learning framework for efficiently synthesizing long, diversified gesture sequences from brief training videos, significantly reducing data requirements. Features in the embodiments disclosed herein may also provide a disentangled module with a state bank to facilitate the learning of unpaired pose and audio embedding or encoding, enabling diverse “one-to-many” mappings in pose generation. Features in the embodiments disclosed herein may further provide a recurrent inference or testing module that may utilize the last generation as an initial pose prior and gesture template for continuous and diverse long-term gesture sequence synthesis.

FIG. 6 is a schematic structural diagram of an example computer system 600 applicable to implementing an electronic device (for example, the server or one of the terminal devices shown in FIG. 1), arranged in accordance with at least some embodiments described herein. It is to be understood that the computer system shown in FIG. 6 is provided for illustration only instead of limiting the functions and applications of the embodiments described herein.

As depicted, the computer system 600 may include a central processing unit (CPU) 605. The CPU 605 may perform various operations and processing based on programs stored in a read-only memory (ROM) 610 or programs loaded from a storage device 640 to a random-access memory (RAM) 615. The RAM 615 may also store various data and programs required for operations of the system 600. The CPU 605, the ROM 610, and the RAM 615 may be connected to each other via a bus 620. An input/output (I/O) interface 625 may also be connected to the bus 620.

The components connected to the I/O interface 625 may further include an input device 630 including a keyboard, a mouse, a digital pen, a drawing pad, or the like; an output device 635 including a display such as a liquid crystal display (LCD), a speaker, or the like; a storage device 640 including a hard disk or the like; and a communication device 645 including a network interface card such as a LAN card, a modem, or the like. The communication device 645 may perform communication processing via a network such as the Internet, a WAN, a LAN, a LIN, a cloud, etc. In an embodiment, a driver 650 may also be connected to the I/O interface 625. A removable medium 655 such as a magnetic disk, an optical disk, a magneto-optical disk, a semiconductor memory, or the like may be mounted on the driver 650 as desired, such that a computer program read from the removable medium 655 may be installed in the storage device 640.

It is to be understood that the processes described with reference to the flowchart of FIG. 5 and/or the processes described in other figures may be implemented as computer software programs or in hardware. The computer program product may include a computer program stored in a computer readable non-volatile and/or non-transitory medium. The computer program includes program codes for performing the method shown in the flowcharts and/or GUIs. In this embodiment, the computer program may be downloaded and installed from the network via the communication device 645, and/or may be installed from the removable medium 655. The computer program, when being executed by the central processing unit (CPU) 605, can implement the above functions specified in the method in the embodiments disclosed herein.

It is to be understood that the disclosed and other solutions, examples, embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., a field programmable gate array, an application specific integrated circuit, or the like.

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory, electrically erasable programmable read-only memory, and flash memory devices; magnetic disks, e.g., internal hard disks or removable disks; magneto optical disks; and compact disc read-only memory and digital video disc read-only memory disks. The processor and the memory can be supplemented by, or incorporated in, special purpose logic circuitry.

It is to be understood that different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by both this disclosure. It is indeed intended that the scope of this disclosure should be determined by a proper legal interpretation and construction of the disclosure, including equivalents, as understood by those of skill in the art relying upon the complete disclosure present at the time of filing.

### Aspects

It is appreciated that any one of aspects can be combined with each other.

Aspect 1. A method for generating a video, the method comprising: encoding an input audio into a plurality of audio features, and encoding a first pose state into a first pose feature; constructing a first latent encoding having the audio features and the first pose feature; encoding a second pose state into a second pose feature, and constructing a second latent encoding having the audio features and the second pose feature; decoding features in the first latent encoding in to first sequences, and decoding features in the second latent encoding in to second sequences; and rendering the video based on the first sequences and/or the second sequences, wherein the first pose feature, the second pose feature, and each of the audio features respectively corresponds to one frame; and the first pose state is different from the second pose state.

Aspect 2. The method of aspect 1, further comprising: applying a first noise to the first pose state before encoding the first pose state.

Aspect 3. The method of aspect 1 or aspect 2, further comprising: applying a second noise to the second pose state before encoding the second pose state.

Aspect 4. The method of any one of aspects 1-3, wherein the constructing of the first latent encoding includes: duplicating the first pose feature into a plurality of first features; respectively concatenating each of the audio features and each of the first features.

Aspect 5. The method of any one of aspects 1-4, wherein the constructing of the second latent encoding includes: duplicating the second pose feature into a plurality of second features; respectively concatenating each of the audio features and each of the second features.

Aspect 6. The method of any one of aspects 1-5, further comprising: obtaining a last sequence from the first sequences; and replacing the first pose state with a third pose state that corresponds to the last sequence for a next iteration in a testing or inference phase.

Aspect 7. The method of any one of aspects 1-6, wherein the first pose state is determined from a first video clip sampled from a video space, the second pose state is determined from a second video clip sampled from the video space, and the first video clip is different from the second video clip.

Aspect 8. A video generation system in machine learning, the system comprising: a memory to store an input audio; and a processor to: encode the input audio into a plurality of audio features, and encode a first pose state into a first pose feature; construct a first latent encoding having the audio features and the first pose feature; encode a second pose state into a second pose feature, and construct a second latent encoding having the audio features and the second pose feature; decode features in the first latent encoding in to first sequences, and decode features in the second latent encoding in to second sequences; and render a video based on the first sequences and/or the second sequences, wherein the first pose feature, the second pose feature, and each of the audio features respectively corresponds to one frame; and the first pose state is different from the second pose state.

Aspect 9. The system of aspect 8, wherein the processor is to further: apply a first noise to the first pose state before encoding the first pose state.

Aspect 10. The system of aspect 8 or aspect 9, wherein the processor is to further: apply a second noise to the second pose state before encoding the second pose state.

Aspect 11. The system of any one of aspects 8-10, wherein the processor is to further: duplicate the first pose feature into a plurality of first features; respectively concatenate each of the audio features and each of the first features.

Aspect 12. The system of any one of aspects 8-11, wherein the processor is to further: duplicate the second pose feature into a plurality of second features; respectively concatenate each of the audio features and each of the second features.

Aspect 13. The system of any one of aspects 8-12, wherein the processor is to further: obtain a last sequence from the first sequences; and replace the first pose state with a third pose state that corresponds to the last sequence for a next iteration in a testing or inference phase.

Aspect 14. A non-transitory computer-readable medium having computer-executable instructions stored thereon that, upon execution, cause one or more processors to perform operations comprising: encoding an input audio into a plurality of audio features, and encoding a first pose state into a first pose feature; constructing a first latent encoding having the audio features and the first pose feature; encoding a second pose state into a second pose feature, and constructing a second latent encoding having the audio features and the second pose feature; decoding features in the first latent encoding in to first sequences, and decoding features in the second latent encoding in to second sequences; and rendering a video based on the first sequences and/or the second sequences, wherein the first pose feature, the second pose feature, and each of the audio features respectively corresponds to one frame; and the first pose state is different from the second pose state.

Aspect 15. The computer-readable medium of aspect 14, the operations further comprise: applying a first noise to the first pose state before encoding the first pose state.

Aspect 16. The computer-readable medium of aspect 14 or aspect 15, the operations further comprise: applying a second noise to the second pose state before encoding the second pose state.

Aspect 17. The computer-readable medium of any one of aspects 14-16, wherein the constructing of the first latent encoding includes: duplicating the first pose feature into a plurality of first features; respectively concatenating each of the audio features and each of the first features.

Aspect 18. The computer-readable medium of any one of aspects 14-17, wherein the constructing of the second latent encoding includes: duplicating the second pose feature into a plurality of second features; respectively concatenating each of the audio features and each of the second features.

Aspect 19. The computer-readable medium of any one of aspects 14-18, the operations further comprise: obtaining a last sequence from the first sequences; and replacing the first pose state with a third pose state that corresponds to the last sequence for a next iteration in a testing or inference phase.

Aspect 20. The computer-readable medium of any one of aspects 14-19, wherein the first pose state is determined from a first video clip sampled from a video space, the second pose state is determined from a second video clip sampled from the video space, and the first video clip is different from the second video clip.

The terminology used in this specification is intended to describe particular embodiments and is not intended to be limiting. The terms “a,” “an,” and “the” include the plural forms as well, unless clearly indicated otherwise. The terms “comprises” and/or “comprising,” when used in this specification, specify the presence of the stated features, integers, steps, operations, elements, and/or components, but do not preclude the presence or addition of one or more other features, integers, steps, operations, elements, and/or components.

With regard to the preceding description, it is to be understood that changes may be made in detail, especially in matters of the construction materials employed and the shape, size, and arrangement of parts without departing from the scope of the present disclosure. This specification and the embodiments described are exemplary only, with the true scope and spirit of the disclosure being indicated by the claims that follow.

What is claimed is:

1. A method for video generation in machine learning, the method comprising:
encoding an input audio into a plurality of audio features, and encoding a first pose state into a first pose feature;
constructing a first latent encoding having the audio features and the first pose feature;
encoding a second pose state into a second pose feature, and constructing a second latent encoding having the audio features and the second pose feature;
decoding features in the first latent encoding in to first sequences, and decoding features in the second latent encoding in to second sequences; and
rendering a video based on the first sequences,
wherein the first pose feature, the second pose feature, and each of the audio features respectively corresponds to one frame; and the first pose state is different from the second pose state.

2. The method of claim 1, further comprising:
applying a first noise to the first pose state before encoding the first pose state.

3. The method of claim 1, further comprising:
applying a second noise to the second pose state before encoding the second pose state.

4. The method of claim 1, wherein the constructing of the first latent encoding includes:
duplicating the first pose feature into a plurality of first features; and
respectively concatenating each of the audio features and each of the first features.

5. The method of claim 1, wherein the constructing of the second latent encoding includes:
duplicating the second pose feature into a plurality of second features; and
respectively concatenating each of the audio features and each of the second features.

6. The method of claim 1, further comprising:
obtaining a last sequence from the first sequences; and
replacing the first pose state with a third pose state that corresponds to the last sequence for a next iteration in a testing phase.

7. The method of claim 1, wherein the first pose state is determined from a first video clip sampled from a video space, the second pose state is determined from a second video clip sampled from the video space, and the first video clip is different from the second video clip.

8. A video generation system in machine learning, the system comprising:
a memory to store an input audio; and
a processor to:
encode the input audio into a plurality of audio features, and encode a first pose state into a first pose feature;
construct a first latent encoding having the audio features and the first pose feature;
encode a second pose state into a second pose feature, and construct a second latent encoding having the audio features and the second pose feature;
decode features in the first latent encoding in to first sequences, and decode features in the second latent encoding in to second sequences; and
render a video based on the first sequences,
wherein the first pose feature, the second pose feature, and each of the audio features respectively corresponds to one frame; and the first pose state is different from the second pose state.

9. The system of claim 8, wherein the processor is to further:
apply a first noise to the first pose state before encoding the first pose state.

10. The system of claim 8, wherein the processor is to further:
apply a second noise to the second pose state before encoding the second pose state.

11. The system of claim 8, wherein the processor is to further:
duplicate the first pose feature into a plurality of first features; and
respectively concatenate each of the audio features and each of the first features.

12. The system of claim 8, wherein the processor is to further:
duplicate the second pose feature into a plurality of second features; and
respectively concatenate each of the audio features and each of the second features.

13. The system of claim 8, wherein the processor is to further:
obtain a last sequence from the first sequences; and
replace the first pose state with a third pose state that corresponds to the last sequence for a next iteration in a testing phase.

14. A non-transitory computer-readable medium having computer-executable instructions stored thereon that, upon execution, cause one or more processors to perform operations comprising:
encoding an input audio into a plurality of audio features, and encoding a first pose state into a first pose feature;
constructing a first latent encoding having the audio features and the first pose feature;
encoding a second pose state into a second pose feature, and constructing a second latent encoding having the audio features and the second pose feature;
decoding features in the first latent encoding in to first sequences, and decoding features in the second latent encoding in to second sequences; and
rendering a video based on the first sequences,
wherein the first pose feature, the second pose feature, and each of the audio features respectively corresponds to one frame; and the first pose state is different from the second pose state.

15. The computer-readable medium of claim 14, the operations further comprise:
applying a first noise to the first pose state before encoding the first pose state.

16. The computer-readable medium of claim 14, the operations further comprise:
applying a second noise to the second pose state before encoding the second pose state.

17. The computer-readable medium of claim 14, wherein the constructing of the first latent encoding includes:
duplicating the first pose feature into a plurality of first features; and
respectively concatenating each of the audio features and each of the first features.

18. The computer-readable medium of claim 14, wherein the constructing of the second latent encoding includes:
duplicating the second pose feature into a plurality of second features; and
respectively concatenating each of the audio features and each of the second features.

19. The computer-readable medium of claim 14, the operations further comprise:
obtaining a last sequence from the first sequences; and
replacing the first pose state with a third pose state that corresponds to the last sequence for a next iteration in a testing phase.

20. The computer-readable medium of claim 14, wherein the first pose state is determined from a first video clip sampled from a video space, the second pose state is determined from a second video clip sampled from the video space, and the first video clip is different from the second video clip.
